(19) United States
(12) Patent Application Publication
(10) Pub. No.: US 2021/0340810 A1
(43) Pub. Date: Nov. 4, 2021

(54) Door And Window Floodproofing Assembly

(71) Applicant: Roy Kidd, Houston, TX (US)

(72) Inventor: Roy Kidd, Houston, TX (US)

(21) Appl. No.: 16/862,160

(22) Filed: Apr. 29, 2020

(51) Int. Cl. E06B 9/06; E05B 65/00; E05C 19/14

(52) U.S. Cl. CPC E06B 9/06; E06B 2009/007; E05C 19/14; E05B 65/001

(57) ABSTRACT

A door and window floodproofing assembly for preventing flood waters from entering a building includes an inflatable sealer apparatus and a battery cover apparatus. The inflatable sealer apparatus comprises a sealer body having a sealer front side, a sealer back side, and a sealer perimeter defining a sealer inside. The sealer inside is inflatable and dimensioned to fit within a door jamb or a window frame. A sealer flap is flexibly coupled to the sealer perimeter adjacent the sealer back side. The battery cover apparatus comprises a panel having a panel front side, a panel back side, and a panel perimeter. A plurality of latches is coupled to the panel front side adjacent the panel perimeter. A plurality of receivers is selectively engageable with the plurality of latches. Each receiver is coupled to the door jamb or the window frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to door and window sealing devices and more particularly pertains to a new door and window sealing device for preventing flood waters from entering a building.

### (2) Description of Related Art Including Information Disclosed Under 37 CFR 1.97 and 1.98

The prior art relates to door and window sealing devices. Existing devices serve to seal the edges around a door or window, or as gaskets around the hardware used for mounting. Existing devices lack inflatable portions that cover the entirety of the door or window sections as well as securable battery covers.

### BRIEF SUMMARY OF THE INVENTION

An embodiment of the disclosure meets the needs presented above by generally comprising an inflatable sealer apparatus and a battery cover apparatus. The inflatable sealer apparatus comprises a sealer body having a sealer front side, a sealer back side, and a sealer perimeter defining a sealer inside. The sealer inside is inflatable and configured and dimensioned to fit within a door jamb or a window frame. A sealer flap is flexibly coupled to the sealer perimeter adjacent the sealer back side. The battery cover apparatus comprises a panel having a panel front side, a panel back side, and a panel perimeter. A plurality of latches is coupled to the panel front side adjacent the panel perimeter. A plurality of receivers is selectively engageable with the plurality of latches. Each receiver is configured to be coupled to the door jamb or the window frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front elevation view of a door and window floodproofing assembly according to an embodiment of the disclosure.

FIG. 2 is a rear elevation view of an embodiment of the disclosure.

FIG. 3 is a side elevation view of an embodiment of the disclosure.

FIG. 4 is a top plan view of an embodiment of the disclosure.

FIG. 5 is a cross-sectional view of an embodiment of the disclosure along the line 5-5 of FIG. 2.

FIG. 6 is an in-use view of an embodiment of the disclosure.

FIG. 7 is a cross-sectional view of an embodiment of the disclosure along the line 7-7 of FIG. 6.

FIG. 8 is a detail view of an embodiment of the disclosure.

FIG. 9 is a detail view of an embodiment of the disclosure.

FIG. 10 is a detail view of an embodiment of the disclosure.

### DETAILED DESCRIPTION OF THE INVENTION

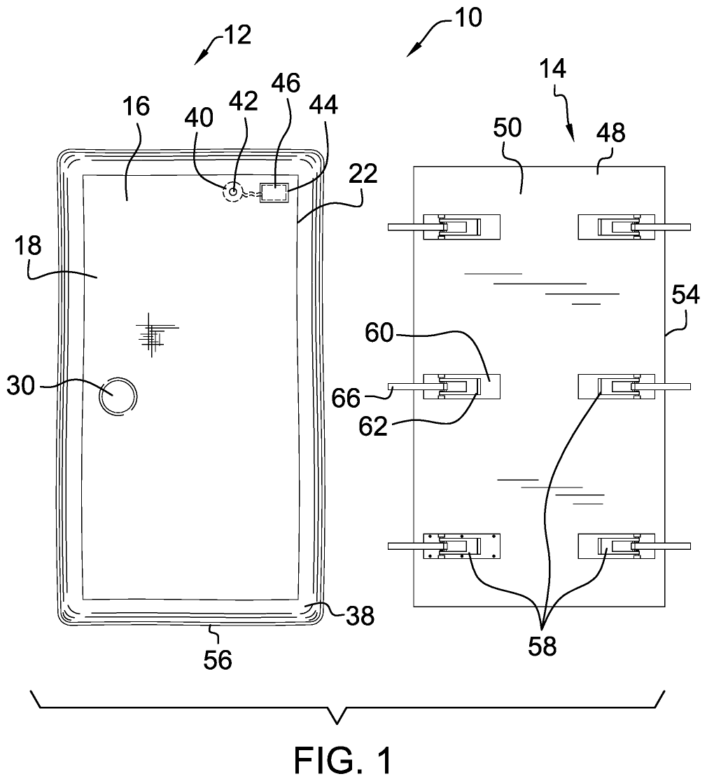

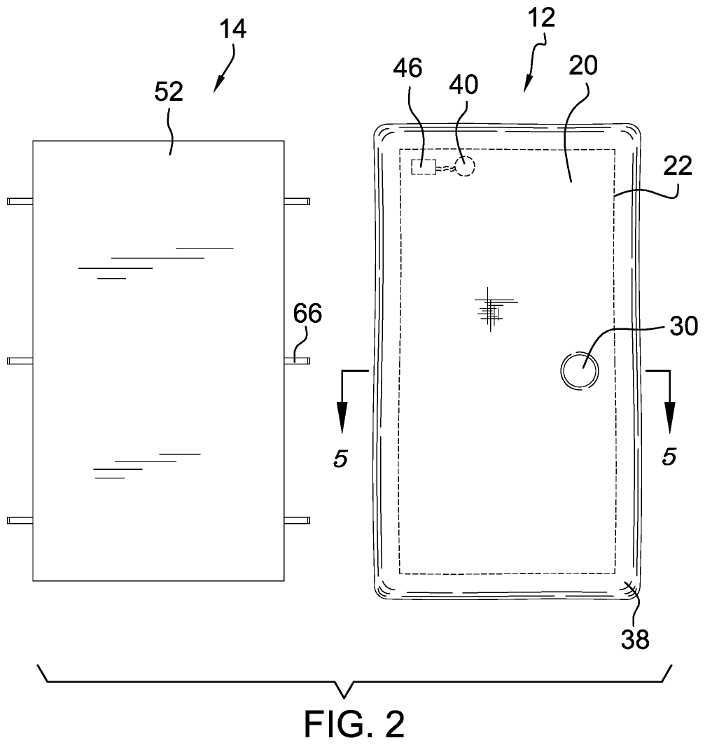

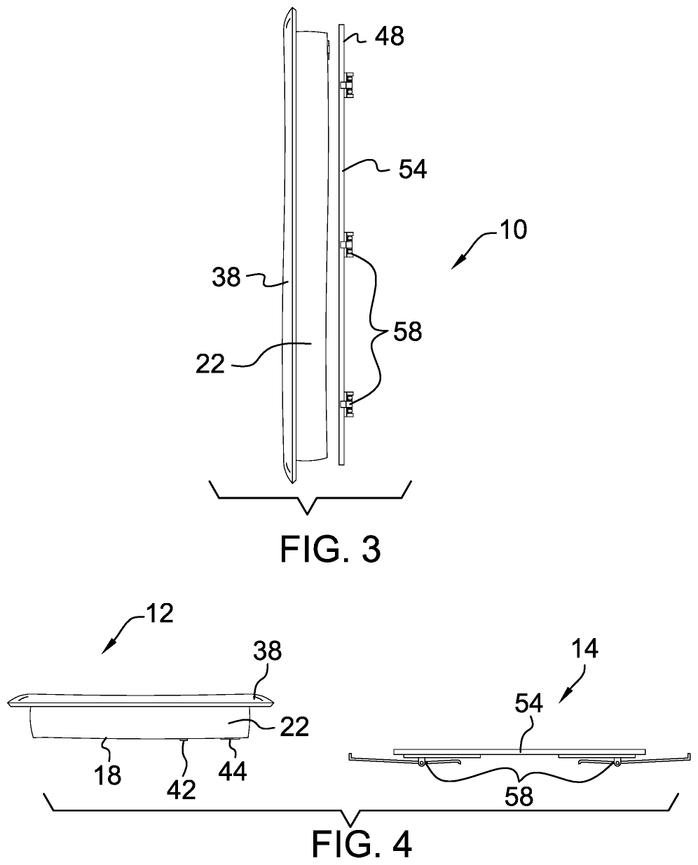

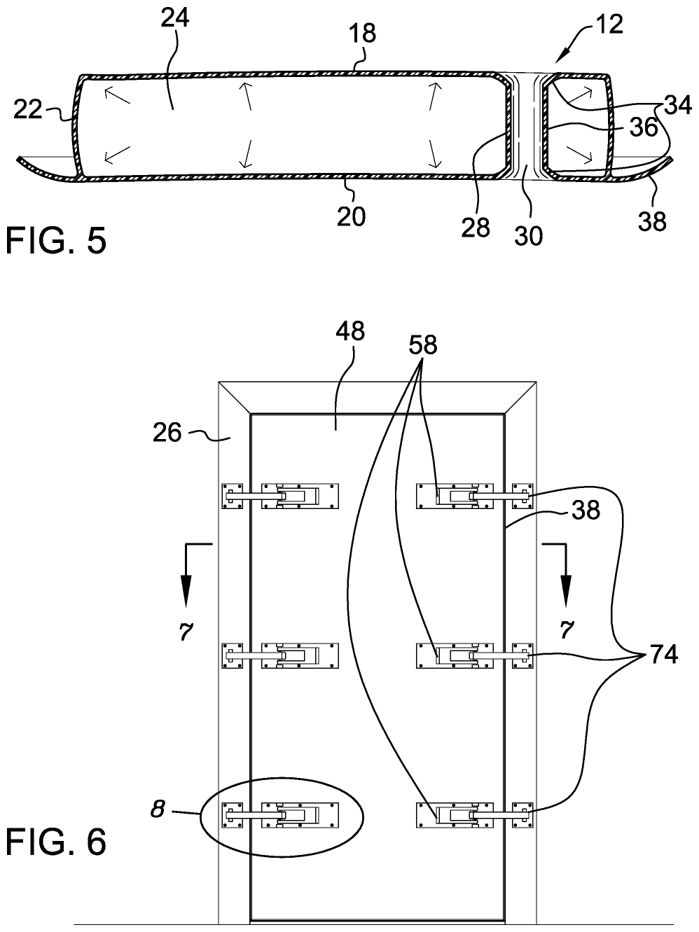

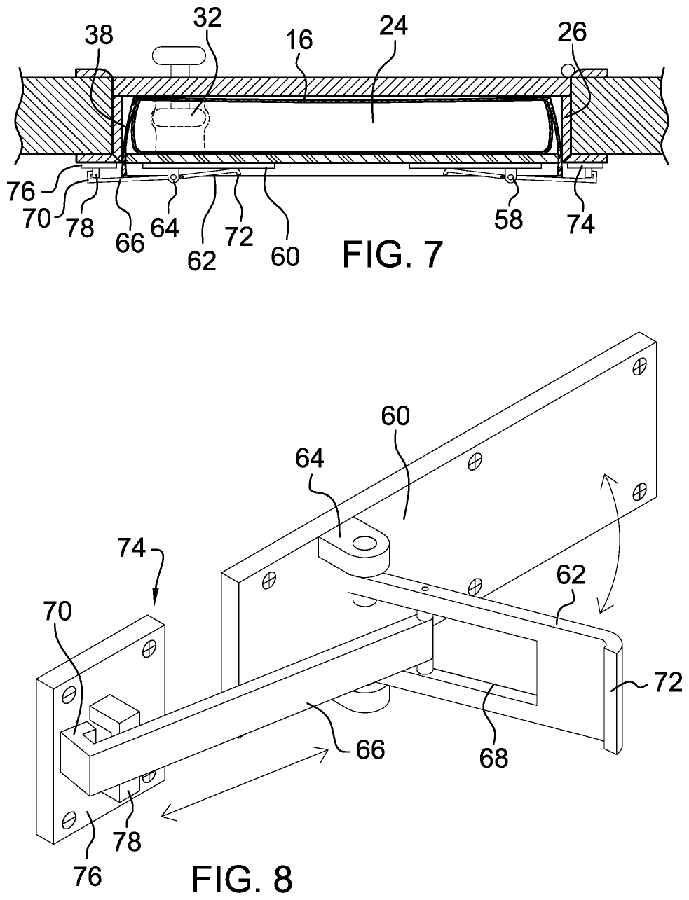

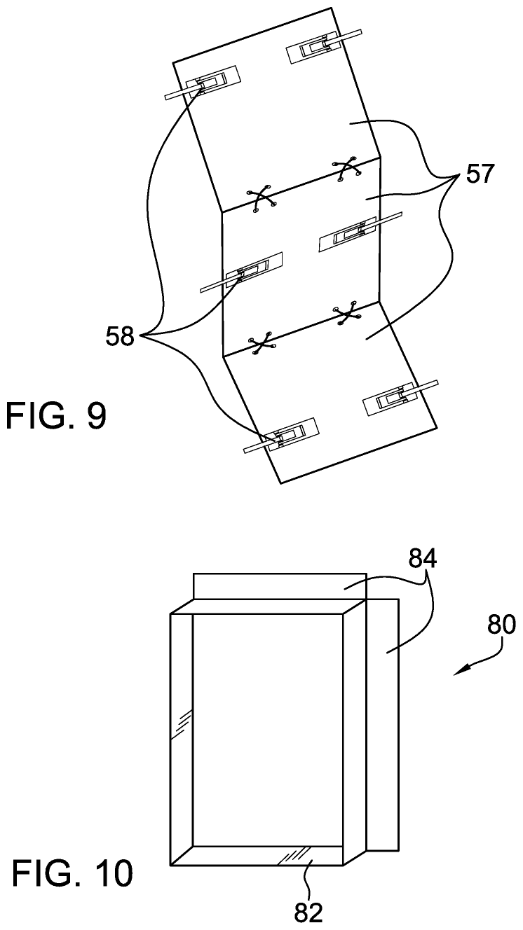

With reference now to the drawings, and in particular to FIGS. 1 through 10 thereof, a new door and window sealing device embodying the principles and concepts of an embodiment of the disclosure and generally designated by the reference numeral 10 will be described.

As best illustrated in FIGS. 1 through 10, the door and window floodproofing assembly 10 generally comprises an inflatable sealer apparatus 12 and a battery cover apparatus 14. The inflatable sealer apparatus 12 comprises a sealer body 16 having a sealer front side 18, a sealer back side 20, and a sealer perimeter 22 defining a sealer inside 24. The sealer inside 24 is inflatable and configured and dimensioned to fit within a door jamb 26 or a window frame. The sealer body 16 may have a knob channel 28 extending from the sealer front side 18 to the sealer back side 20. The knob channel 28 defines a knob aperture 30 configured to receive a doorknob 32. The knob channel 28 may have a pair of flared portions 34 and a medial straight portion 36. The flared portions 34 receive the doorknob 32 before it is sealingly secured within the straight portion 36. A sealer flap 38 is flexibly coupled to the sealer perimeter 22 adjacent the sealer back side 20. The sealer flap 38 may have rounded corners.

An air compressor 40 may be coupled to the sealer body and is in fluid communication with the sealer inside 24. The air compressor 40 has a control button 42 extending through the sealer front side 18. The air compressor 40 may also have a battery cover 44 to expose a replaceable battery 46.

The battery cover apparatus 14 comprises a panel 48 having a panel front side 50, a panel back side 52, and a panel perimeter 54. The panel perimeter 54 may be dimensioned to be larger than the sealer perimeter 22 and smaller than a flap perimeter 56 of the sealer flap. The panel 48 may include a plurality of panel sections 57 with each panel section 57 slidably or foldably coupled to the adjacent panel section 57 of the plurality of panel sections.

A plurality of latches 58 is coupled to the panel 48. Each latch 58 of the plurality of latches may have a latch plate 60 coupled to the panel front side 50 adjacent the panel perimeter 54. A latch pull 62 is pivotably coupled to a pair of ears 64 of the latch plate. A latch arm 66 is pivotably coupled within a pull channel 68 of the latch pull. The latch arm 66 may have a hooked end 70 and the latch pull 62 may have a curved distal end 72. The curved distal end 72 provides a grip point for a user to move the latch pull 62.

A plurality of receivers 74 is selectively engageable with the plurality of latches 58. Each receiver 74 of the plurality of receivers may have a receiver plate 76 and a receiver catch 78 coupled to the receiver plate 76. The receiver catch 78 selectively receives the hooked end 70 of the latch arm 66. Each receiver 74 is configured to be coupled to the door jamb 26 or the window frame.

For applications where the window frame has no exterior ledge, the combination 10 may further comprise a window box 80. The window box 80 has a box perimeter 82 and a plurality of support flanges 84 extending perpendicularly from the box perimeter 82. The box perimeter 82 is configured to be coupled around the window and the box perimeter 82 receives the inflatable sealer apparatus 12.

In use, the sealer body 16 is inflated using the air compressor 40 and placed within the door jamb 26, the window frame, or the window box 80. The sealer flap 38 folds back out past the sealer front side 18 and is then pinched with the panel 48. The plurality of latches 58 are engaged with the plurality of receivers 74 to tighten the panel 48 in place. For certain window applications multiple inflatable sealer apparatuses 12 and battery cover apparatuses 14 may be used to cover different panes or sections.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A door and window floodproofing assembly comprising:
an inflatable sealer apparatus comprising:
a sealer body having a sealer front side, a sealer back side, and a sealer perimeter defining a sealer inside, the sealer inside being inflatable, the sealer body being configured and dimensioned to fit within a door jamb or a window frame; and
a sealer flap coupled to the sealer body, the sealer flap being flexibly coupled to the sealer perimeter adjacent the sealer back side; and
a battery cover apparatus comprising:
a panel having a panel front side, a panel back side, and a panel perimeter;
a plurality of latches coupled to the panel front side adjacent the panel perimeter; and
a plurality of receivers, the plurality of receivers being selectively engageable with the plurality of latches, each receiver being configured to be coupled to the door jamb or the window frame.

2. The door and window floodproofing assembly of claim 1 further comprising the sealer body having a knob channel extending from the sealer front side to the sealer back side, the knob channel defining a knob aperture configured to receive a doorknob.

3. The door and window floodproofing assembly of claim 1 further comprising the panel perimeter being dimensioned to be larger than the sealer perimeter and smaller than a flap perimeter of the sealer flap.

4. The door and window floodproofing assembly of claim 1 further comprising an air compressor coupled to the sealer body, the air compressor being in fluid communication with the sealer inside.

5. The door and window floodproofing assembly of claim 4 further comprising the air compressor having a control button extending through the sealer front side.

6. The door and window floodproofing assembly of claim 1 further comprising each latch of the plurality of latches having a latch plate coupled to the panel front side, a latch pull pivotably coupled to the latch plate, and a latch arm pivotably coupled to the latch pull, the latch arm having a hooked end.

7. The door and window floodproofing assembly of claim 6 further comprising each receiver of the plurality of receivers having a receiver plate and a receiver catch coupled to the receiver plate, the receiver catch selectively receiving the hooked end.

8. The door and window floodproofing assembly of claim 6 further comprising the latch pull being pivotably coupled to a pair of ears of the latch plate, the latch arm being pivotably coupled within a pull channel of the latch pull.

9. The door and window floodproofing assembly of claim 6 further comprising the latch pull having a curved distal end.

10. The door and window floodproofing assembly of claim 1 further comprising a window box, the window box having a box perimeter and a plurality of support flanges extending perpendicularly from the box perimeter, the box perimeter receiving the inflatable sealer apparatus.

11. The door and window floodproofing assembly of claim 1 further comprising the panel including a plurality of panel sections, each panel section being slidably or foldably coupled to the adjacent panel section of the plurality of panel sections.

12. A door and window floodproofing assembly comprising:
an inflatable sealer apparatus comprising:
a sealer body having a sealer front side, a sealer back side, and a sealer perimeter defining a sealer inside, the sealer inside being inflatable, the sealer body being configured and dimensioned to fit within a door jamb or a window frame, the sealer body having a knob channel extending from the sealer front side to the sealer back side, the knob channel defining a knob aperture configured to receive a doorknob;
an air compressor coupled to the sealer body, the air compressor being in fluid communication with the sealer inside, the air compressor having a control button extending through the sealer front side; and
a sealer flap coupled to the sealer body, the sealer flap being flexibly coupled to the sealer perimeter adjacent the sealer back side; and
a battery cover apparatus comprising:
a panel having a panel front side, a panel back side, and a panel perimeter, the panel perimeter being dimensioned to be larger than the sealer perimeter and smaller than a flap perimeter of the sealer flap;
a plurality of latches coupled to the panel, each latch of the plurality of latches having a latch plate coupled to the panel front side adjacent the panel perimeter, a latch pull pivotably coupled to a pair of ears of the latch plate, and a latch arm pivotably coupled within a pull channel of the latch pull, the latch arm having a hooked end, the latch pull having a curved distal end; and
a plurality of receivers, the plurality of receivers being selectively engageable with the plurality of latches, each receiver of the plurality of receivers having a receiver plate and a receiver catch coupled to the receiver plate, the receiver catch selectively receiving the hooked end, each receiver being configured to be coupled to the door jamb or the window frame.

13. The door and window floodproofing assembly of claim 12 further comprising a window box, the window box having a box perimeter and a plurality of support flanges extending perpendicularly from the box perimeter, the box perimeter receiving the inflatable sealer apparatus.

14. The door and window floodproofing assembly of claim 12 further comprising the panel including a plurality of panel sections, each panel section being slidably or foldably coupled to the adjacent panel section of the plurality of panel sections.
